(19) United States
(12) Patent Application Publication
(10) Pub. No.: US 2014/0326182 A1
(43) Pub. Date: Nov. 6, 2014

(54) Continuous Substrate Processing Apparatus

(71) Applicant: Areesys Corporation, Fremont, CA (US)

(72) Inventors: Kai-An Wang, Cupertino, CA (US); Michael Z. Wong, Castro Valley, CA (US)

(73) Assignee: Areesys Corporation, Fremont, CA (US)

(21) Appl. No.: 14/250,575

(22) Filed: Apr. 11, 2014

Related U.S. Application Data
(60) Provisional application No. 61/819,001, filed on May 3, 2013.

(51) Int. Cl. B05C 9/06

(52) U.S. Cl. CPC B05C 9/06
USPC 118/719; 118/500; 118/50

(57) ABSTRACT

A processing system includes a first processing module that includes a first chamber; and a first processing source that can deposit a first material on a web substrate. An isolation module includes an isolation chamber, and one or more segregation walls that define a sequence of compartments in the isolation chamber. The first chamber is connected to a first compartment in the sequence of compartments. Each of the segregation walls includes an opening to allow the web substrate to pass through. A second processing module includes a second chamber in connection with a last compartment in the sequence of compartments in the isolation module, and a second processing source configured to deposit a second material on the web substrate. A transport mechanism moves the web substrate continuously through the first processing module, the isolation module, and the second processing module.

### BACKGROUND OF THE INVENTION

The present application relates to material deposition technologies, and more specifically to continuous deposition systems.

Flexible sheet materials such as thin stainless steel foil, polymer web, and paper are widely used as substrates supporting thick films (˜100's microns) or thin films (˜10's to 100's nanometers) of other functional materials. Examples of common functional materials include metals, semiconductors, insulators, and inorganic, organic or composite materials. The functional materials can be deposited or coated by vacuum-based technologies (e.g. sputtering, thermal evaporation, electron-beam evaporation, plasma enhanced chemical vapor deposition and atomic layer deposition), or non-vacuum-based technologies (e.g. chemical bath deposition, spin-on, sol-gel, spray-on, screen printing and inkjet printing). Film process technology using flexible substrates is often called “roll-to-roll process” (RTR process), or “web process”. Roll-to-roll processes have been used in some traditional industries like food vacuum packaging, and are finding more and more applications in flexible electronics. Flexible electronics include flexible circuit boards, radio-frequency identifications (RFIDs), fingerprint sensors, flexible displays, transparent displays, touch sensors, touch screens, flexible solar cells and numerous emerging devices.

Referring to FIG. 1, a conventional system 100 is configured to carry out state-of-the-art roll-to-roll process in vacuum. A vacuum chamber 110 is evacuated to a base pressure (typically 10⁻⁵˜10⁻⁷ Torr) by a vacuum pumping system (not shown). Inside the vacuum chamber 110, a release roller 120 holds a web substrate 130. The web substrate 130 is unwound from the release roller 120, wrapped around a cylindrical drum 140, and collected by a take-up roller 150. Vacuum deposition sources 160, 170 are mounted inside two partitions defined by separating walls 180. The deposition sources 160 and 170 can be used for sputter deposition, thermal evaporation, or plasma enhanced chemical vapor deposition. For example, the disclosed apparatus and system can be suitable for plasma assisted evaporation coating of metals, oxides, nitrides, polymers. By controlling the take-up roller 150 and the release roller 120, the web substrate 130 is transported on the drum 140, to the vicinity of the deposition sources 160, 170. The deposition sources 160, 170 deposit materials on the surface of the web substrate 130 to form a thin film of the deposited materials. The separating walls 180 between the deposition sources 160, 170 can minimize cross contaminations between the deposition sources 160, 170 if they contain different materials.

The above described roll-to-roll process system suffers from a number of major drawbacks. Referring to FIG. 1 again, the edges of separating walls 180 and the surface of the drum 140 are separated by gaps 190 to allow the web substrate 130 to pass through from source to source. The separating walls 190 cannot provide effective isolation between sources: vapor from the deposition source 160 can easily reach the deposition source 170, and vice versa. The cross contamination between the deposition sources can cause unwanted process drifts in production, and defective devices.

Moreover, it is very difficult to implement depositions of very different atmospheres in the same vacuum chamber. For example, atmospheres in vacuum chambers often differ significantly for regular sputtering depositions (only inert gas, e.g. argon is used) and reactive sputtering deposition (both inert and reactive gases, e.g. argon and oxygen gases). In another example, physical sputtering deposition and chemical vapor deposition also require different vacuum pressures (e.g. ˜5 mTorr and ˜500 mTorr respectively). Furthermore, the throughput of the web-based system 100 is limited by the slowest deposition source, which can significantly limit the productivity of the entire equipment.

Therefore there is a need for improved film deposition system that can provide improved process flexibility and higher throughput in processing of continuous substrates.

### SUMMARY OF THE INVENTION

The present application discloses highly modularized processing systems using continuous flexible substrates. The disclosed processing systems offer flexibility in process, scalability from development, pilot to production, as well as higher productivity in mass production. The continuous flexible substrate may be flexible polymer webs, metal foils, papers, etc. The continuous flexible substrate can also serve as a carrier on which small, rigid substrates or low profile 3-dimentional workpieces are mounted.

The disclosed processing systems can accommodate process techniques having wide pressure requirements on a single continuous substrate in a processing system. The processing techniques can range from low pressure vacuum deposition processes to atmospheric wet solution-based processes for coating, spraying, printing, and surface treatments.

Because of their flexibility and modularity, the disclosed processing systems can fully utilize the process window of each process technique without causing interferences between different techniques.

The disclosed processing systems can eliminate or minimize cross contaminations that are usually associated with conventional single-chamber roll-to-roll processing systems.

Furthermore, unlike some conventional continuous-substrate systems, the throughput of a disclosed processing system is not limited by the rates of individual processes in the continuous workflow.

In one general aspect, the present invention relates to a processing system that includes a first processing module comprising: a first chamber; and a first processing source configured to deposit a first material on a web substrate; an isolation module, comprising: an isolation chamber; and one or more segregation walls that define a sequence of compartments in the isolation chamber, wherein the first chamber is connected to a first compartment in the sequence of compartments, wherein each of the one or more segregation walls includes an opening to allow the web substrate to pass through; a second processing module, comprising: a second chamber in connection with a last compartment in the sequence of compartments in the isolation module; and a second processing source configured to deposit a second material on the web substrate; and a transport mechanism configured to move the web substrate continuously through the first processing module, the isolation module, and the second processing module.

Implementations of the system may include one or more of the following. The first chamber and the isolation chambers can respectively include flanges that connect the first chamber and the isolation chamber, wherein the web substrate is transported through the flanges. The second chamber and the isolation chambers can respectively include flanges that connect the isolation chamber and the second chamber, wherein the web substrate is transported through the flanges. The first processing module can further include one or more vacuum pumps each configured to exhaust gas in one of the compartments in the isolation chamber. The first chamber can be exhausted to a first pressure when the first material is deposited on the web substrate, wherein the second chamber can be exhausted to a second pressure when the second material is deposited on the web substrate, wherein the first pressure is in a range between 1 mTorr to 500 mTorr and wherein the second pressure is in a range between 10 Torr˜760 Torr. The second processing source can deposit the second material on the web substrate by immersing the web substrate in a solution that contains the second material. The first chamber can be exhausted to a first pressure when the first material is deposited on the web substrate, wherein the second chamber can be exhausted to a second pressure when the second material is deposited on the web substrate, wherein a ratio of the first pressure to the second pressure is higher than 100. A ratio of the first pressure to the second pressure can be higher than 1000. The second processing source can deposit the second material on the web substrate by inkjet printing. The second processing source can include a shower-head that is configured to emit a chemical vapor to deposit the second material on the web substrate. The first chamber can be exhausted to a first pressure when the first material is deposited on the web substrate, wherein the second chamber can be exhausted to a second pressure when the second material is deposited on the web substrate, wherein the first pressure is in a range between 1 mTorr to 30 mTorr and wherein the second pressure is in a range between 10⁻⁴˜10⁻⁵ Torr. The first chamber can be exhausted to a first pressure when the first material is deposited on the web substrate, wherein the second chamber can be exhausted to a second pressure when the second material is deposited on the web substrate, wherein at least one of the compartments in the isolation chamber is kept at a third pressure higher than the first pressure and the second pressure by pumping in an inert gas in the one of the compartments. The third pressure the one of the compartments in the isolation chamber can be kept 1 mTorr˜5 mTorr at higher than the first pressure and the second pressure. The first processing source can deposit the first material on the web substrate by sputtering, thermal evaporation, electron-beam evaporation, plasma enhanced chemical vapor deposition, or atomic layer deposition. The web substrate can be made of a steel foil, a polymer web, and a paper web. The first processing module can further include a rigid substrate or a rigid workpiece on the web substrate, wherein an outer surface of the rigid substrate or the rigid workpiece is configured to receive the first material from the first processing source and the second material from the second processing source. The first processing module can further include a third processing source configured to deposit a third material on the web substrate, wherein the first processing source and the third processing source are configured to deposit the first material and the third material on opposite surfaces of the web substrate. The first material can be substantially the same as the third material.

In another general aspect, the present invention relates to a processing system that includes a first processing module comprising: a first chamber; and a first processing source configured to deposit a first material on a web substrate; a first isolation module, comprising: a first isolation chamber; and one or more segregation walls that define a sequence of compartments in the first isolation chamber, wherein the first chamber is connected to a first compartment in the sequence of compartments in the first isolation chamber, wherein each of the one or more segregation walls includes an opening to allow the web substrate to pass through; a second isolation module, comprising: a second isolation chamber; and one or more segregation walls that define a sequence of compartments in the second isolation chamber, wherein a last compartment in the first isolation chamber is connected to a first compartment in the sequence of compartments in the second isolation chamber, wherein each of the one or more segregation walls includes an opening to allow the web substrate to pass through; a second processing module, comprising: a second chamber configured to receive the web substrate from a last compartment in the sequence of compartments in the second isolation module; and a second processing source configured to deposit a second material on the web substrate; and a transport mechanism configured to move the web substrate continuously through the first processing module, the first isolation module, the second isolation module, and the second processing module.

In yet another general aspect, the present invention relates to a double-sided processing module that includes a chamber comprising an entry slit and an exit slit that are configured to pass through a web substrate, wherein the web substrate comprises a first surface and a second surface; a wrap-around roller configured to be in contact with the second surface of the web substrate; a transport mechanism configured to move the web substrate continuously through the entry slit, wrapped around wrap-around roller, and through the exit slit; a first processing source positioned upstream t the wrap-around roller, wherein the first processing source is configured to deposit a first material on the first surface of the web substrate; and a second processing source positioned downstream the wrap-around roller, wherein the second processing source is configured to deposit a second material on the second surface of the web substrate.

These and other aspects, their implementations and other features are described in details in the drawings, the description and the claims.

### BRIEF DESCRIPTION OF THE DRAWINGS

FIG. 1 is a cross-sectional view of a conventional roll-to-roll vacuum process system.

FIG. 2A is a cross-sectional view of a modular vacuum deposition apparatus comprising multiple sources for single-sided depositions in accordance with the present invention.

FIG. 2B is a cross-sectional view of another modular vacuum deposition apparatus comprising multiple sources for dual-sided depositions in accordance with the present invention.

FIG. 2C is a cross-sectional view of another modular vacuum deposition apparatus comprising multiple surrounding deposition sources for dual-sided depositions in accordance with the present invention.

FIG. 2D is a perspective view showing the relationship between the web substrate and a surrounding deposition source in FIG. 2C.

FIG. 2E is a cross-sectional view of another modular vacuum deposition apparatus comprising multiple sources of single-sided deposition, but configured for dual-sided depositions in accordance with the present invention.

FIG. 3 shows a vacuum deposition system composed of multiple interconnected deposition modules maintaining similar processing pressures in accordance with the present invention.

FIG. 4 shows another vacuum deposition system comprising multiple interconnected vacuum deposition modules operating in substantially different processing pressures in accordance with the present invention.

FIG. 5 shows yet another deposition system comprising interconnected vacuum deposition, and non-vacuum, in-air, or solution-based deposition modules in accordance with the present invention.

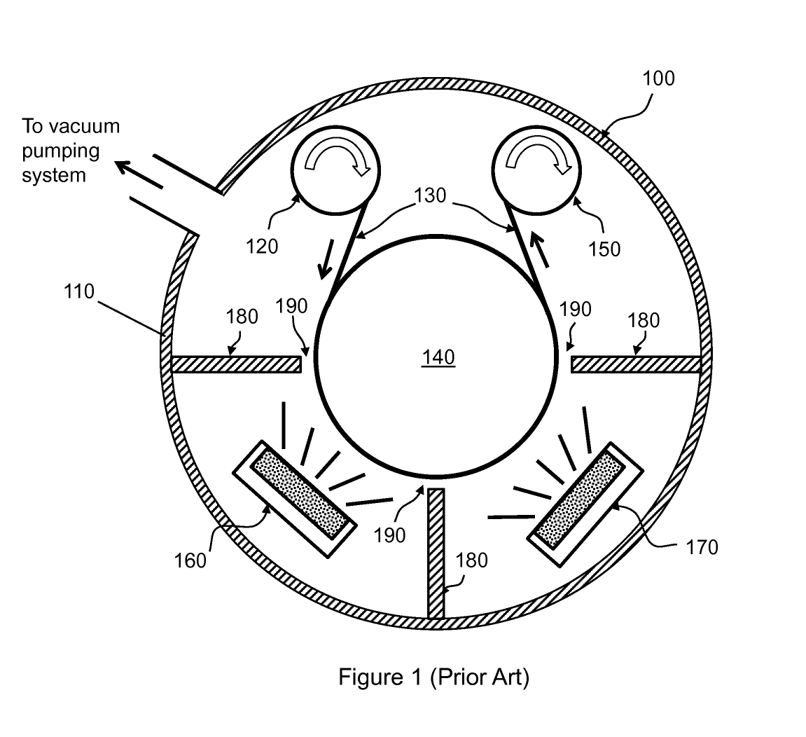

### DETAILED DESCRIPTION OF THE INVENTION

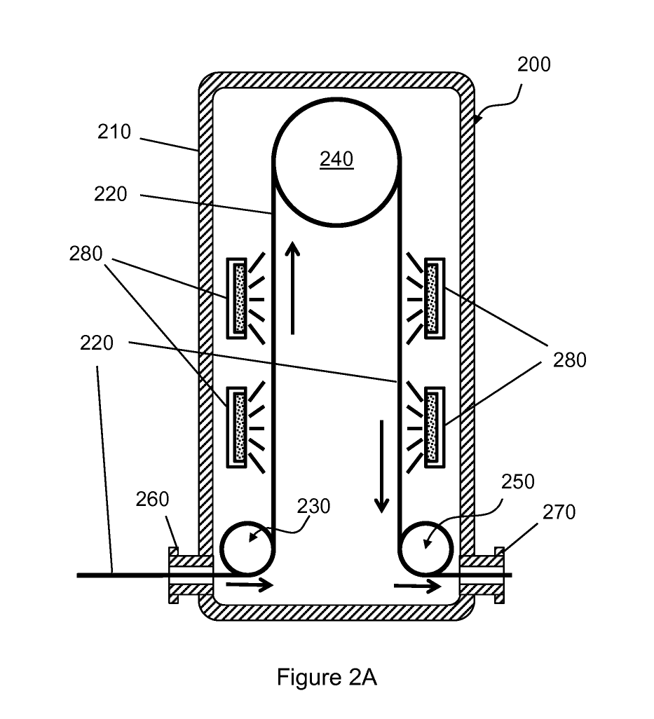

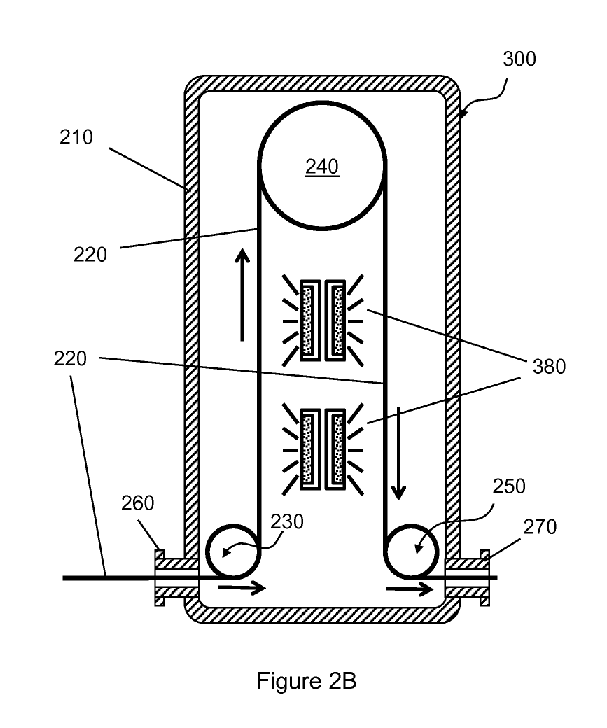

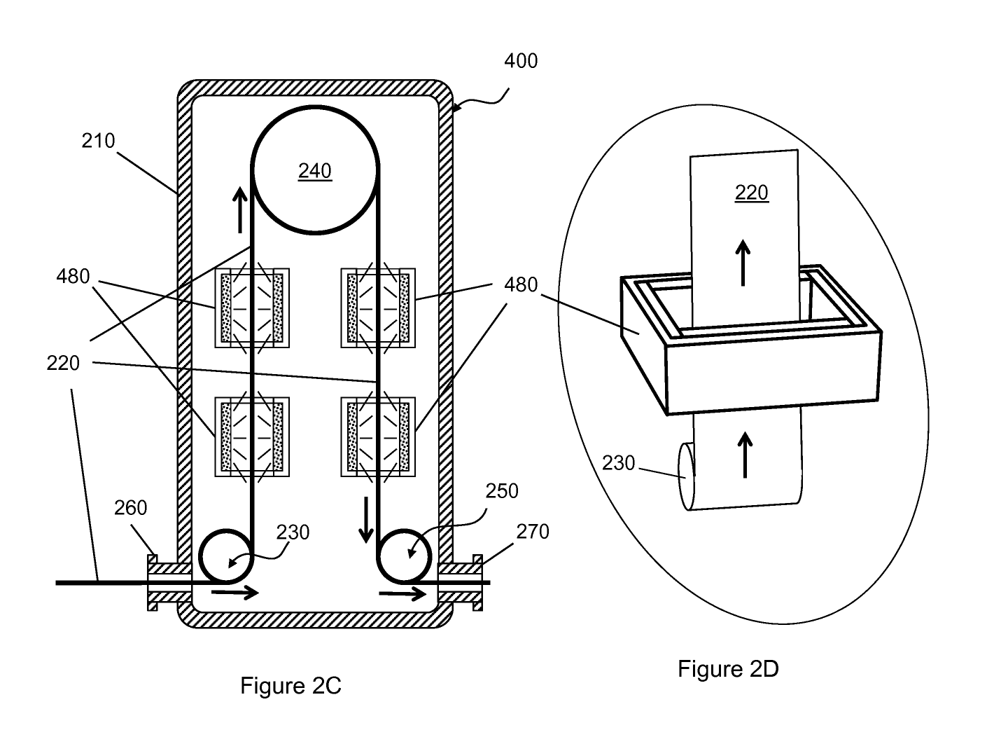

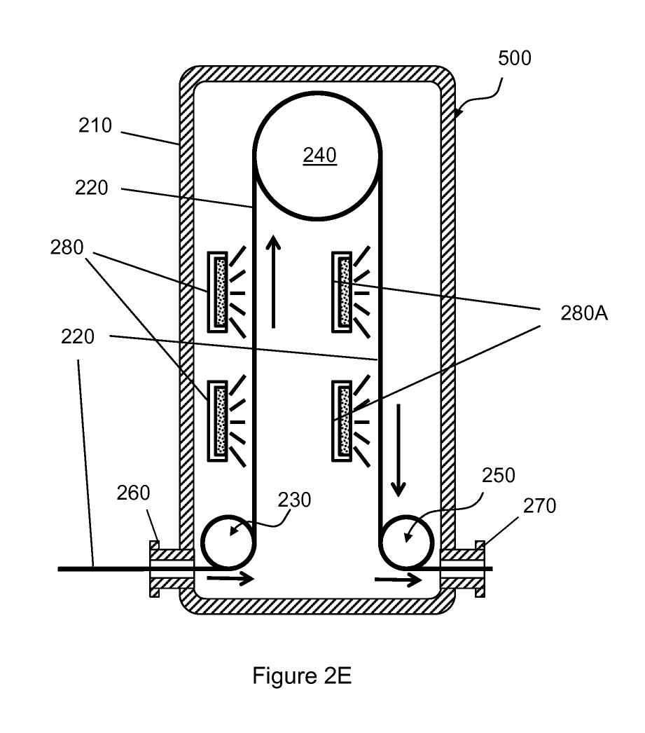

Referring to FIG. 2A, a processing module 200 includes a vacuum chamber 210, an entry slit 260 having a long, narrow opening and a vacuum sealing flange, a guiding roller 230, a wrap-around roller 240, another guiding roller 250, and an exit slit 270. The processing module 200 can also include a vacuum pumping port and pump (not shown) for maintaining vacuum in the vacuum chamber 210. A web substrate 220 is transported into the entry slit 260, guided by the guiding rollers 230, 250 and the wrap-around roller 240, and exits the vacuum chamber 210 through the exit slit 270. Processing sources 280 are mounted in two sides of the wrap-around roller 240 but facing the outer surface of the web substrate 220. As an example, the web substrate 220 can be 0.5 meter wide, 1000 meter long, and 0.1 mm thick. The web substrate 220 can be made of PET (polyethylene terephthalate). The processing sources 280 can provide different deposition materials for different deposition techniques such as sputter deposition, chemical vapor deposition, evaporation, or other suitable techniques. The processing sources 280 can also include an ion cleaning device for plasma pre-treatment for the web substrate 220. In regions of thin film deposition, the transport orientation of the web substrate 220 is substantially vertical in order to minimize particulate forming or collection on coated thin film. The vertical orientation for the web also enables easy expandability if more space is needed to mount more deposition sources, in which case one just needs to design and “stretch” the vacuum chamber 210 taller without increasing the footprint of the chamber 210, hence to save valuable manufacturing floor.

In some embodiments, referring to FIG. 2B, a processing module 300 includes a vacuum chamber 210 and other components in the processing module 200 (shown in FIG. 2A). Processing sources 380 can provide deposition materials on both sides. The processing sources 380 are positioned to deposit materials sequentially on the inner surface of the web substrate 220. The double-sided processing sources 380 can replace two single-sided processing sources to save valuable space in vacuum for more design flexibility. Moreover, single-sided deposition sources can be added to deposit materials on the outer surface of the web substrate 220.

In some embodiments, referring to FIGS. 2C and 2D, a processing module 400 includes a vacuum chamber 210 and other components in the processing modules 200, 300 (shown in FIGS. 2A, 2B). Surrounding deposition sources 480 encircle the web substrate 220 at different processing stations and can coat both sides of the web substrate 220 simultaneously. In another example, the surrounding deposition sources 480 can generate material vapor around the web substrate 220 to provide edge-to-edge material depositions on both sides of the web substrate 220. In another example, the web substrate 220 can carry a plurality of small workpieces on their outer surfaces. The surrounding deposition sources 480 can coat the workpieces from different directions, resulting in more uniform deposition at higher rate of deposition. In some embodiments, the processing module 400 is suitable for coating coronary stents, where a tubular structure can be formed on a sacrificial thin rod by deposition of stent material (e.g., Titanium Nickel alloy) from surrounding directions.

In some embodiments, FIG. 2E shows another processing module 500 for dual-sided depositions. Single-sided processing sources 280 are positioned upstream to a wrap-around roller 240, and are configured to deposit materials on the outer surface of the web substrate 220 that does not come into contact with the wrap-around roller 240. In addition, the single-sided processing sources 280A are positioned downstream to the wrap-around roller 240, and are configured to deposit materials on the inner surface of the web substrate 220 after it touches the wrap-around roller 240. The described configuration can prevent immediately deposited material from contacting with the wrap-around roller 240, which is useful for depositing lower melting temperature materials, such as lithium and indium, which can be easily damaged by touching or scratching after deposition. The materials deposited on the opposite surfaces of the web substrate 220 can be the same material, or different from each other.

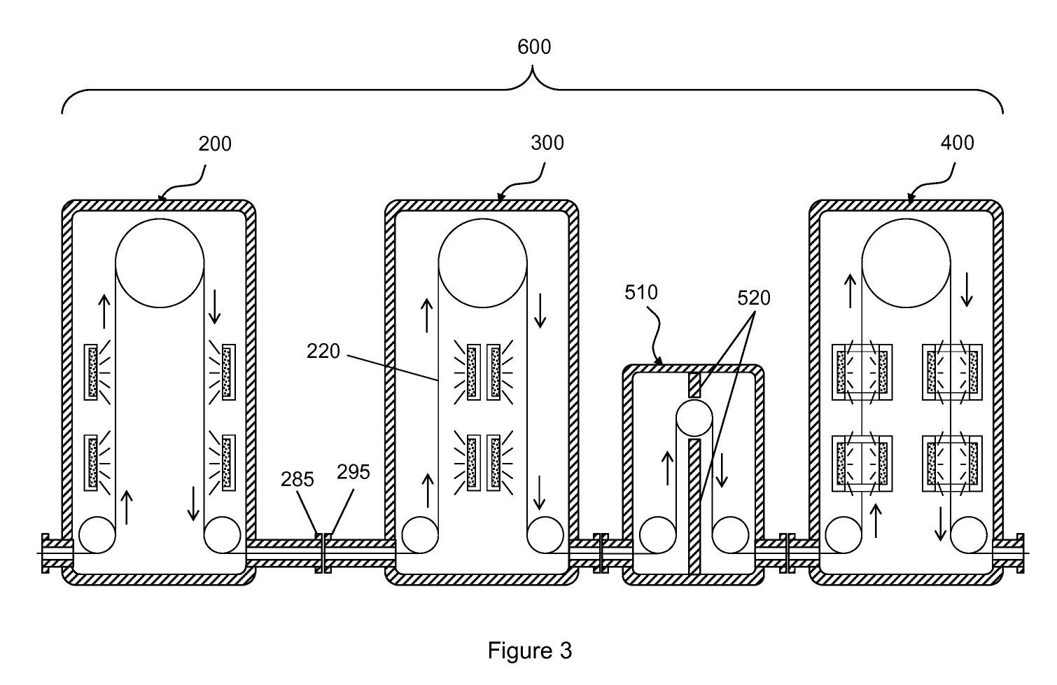

The processing modules 200-500 depicted in FIGS. 2A-2E can be used to form roll-to-roll processing systems in different configurations according to process requirements. In one example, as shown in FIG. 3, a continuous-substrate processing system 600 includes processing modules 200 and 300 that are inter-connected via extended vacuum sealing flanges 285 and 295. The processing modules 300 and 400 are indirectly connected through an isolation module 510. Thus the processing system 600 forms a continuous work flow for a flexible web substrate 220, in which the process pressures in the processing modules 200-400 are similar to each other. One example for the flexible web substrate 220 is a polyethylene terephthalate (PET) web. The extended flanges 285 and 295 keep the process regions in the processing modules 200 and 300 away from each other, which in most cases can effectively minimize cross contaminations between the processing modules 200 and 300.

Continuing with FIG. 3, the processing sources in the processing modules 200 and 300 deposit materials on the web substrate 220 in vacuum environments. Examples of the processing techniques include sputtering, thermal evaporation, electron-beam evaporation, plasma enhanced chemical vapor deposition, or atomic layer deposition. Although the processing pressures and atmospheres in the processing modules 200 and 300 are similar (e.g. ˜1 mTorr to 30 mTorr , both in Argon atmosphere in the case of regular sputtering depositions), different material vapors (e.g. Gold and Aluminum) generated by the processing sources in the processing modules 200 and 300, respectively do not easily diffuse into each other's chamber such that cross contamination is minimized or eliminated.

Still referring to FIG. 3, the processing pressures in the processing modules 300 and 400 fall in the same range of ˜1 mTorr to 30 mTorr; however, the processing atmospheres may be different. The module 300 is configured for regular sputtering deposition in Argon atmosphere, whereas the processing module 400 is configured for reactive sputtering deposition in a mixed atmosphere of Argon and Oxygen, for instance. In this scenario, insertion of an isolation module 510 can adequately separate the two different processing atmospheres between the processing module 300 and the processing module 400. Other processing techniques can be analogized, such as regular evaporation depositions of Gold, Aluminum (no processing gas is used) and reactive evaporation (Oxygen processing gas is used) deposition of Aluminum oxide in the processing modules 200, 300 and 400, respectively. In evaporation depositions, the processing pressures are typically in the order of 10⁻⁴˜10⁻⁵ Torr.

The isolation module 510 includes a segregation wall 520 that separates the isolation module 510 into two compartments, which can further reduce cross contamination between the processing modules 300, 400. The segregation wall 520 includes a slit to allow the web substrate 220 to pass through. The continuous web substrate can all carry small rigid substrates or low profile workpieces. The rigid substrates or low profile workpieces include outer surfaces configured to receive materials from the processing sources.

In some embodiments, the cross-contamination can be further reduced or eliminated by keeping the base pressure in the isolation module 510 slightly higher than the processing pressures in the processing modules 300 and 400. This can be implemented by introducing certain level of flow of inert gas (Argon, for example) into the isolation module 510 to maintain a slightly higher (e.g. 1˜5 mTorr higher) Argon partial pressure; inert gas molecules are thus drawn away from the isolation module 510 and towards the processing modules 300 or 400, wherein the Argon gas molecules are exhausted.

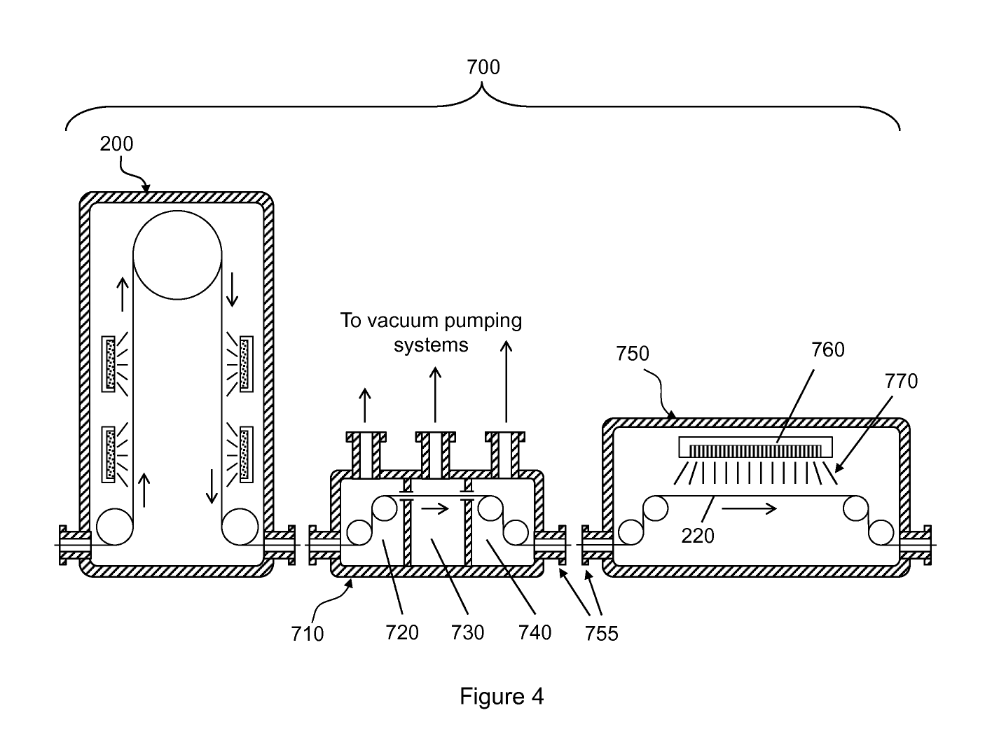

In some applications, a continuous web workflow can include processing steps that require drastically different pressures. For example, inkjet printing of polymer materials is often conducted in a reduced pressure nitrogen gas (e.g. ˜500 Torr). Catalytic chemical vapor deposition of polymer thin films is conducted in pressure of around 50 mTorr. A continuous-substrate processing system 700 shown in FIG. 4 addresses the needs of such applications. The continuous-substrate processing system 700 includes a vacuum processing module 200 and a processing module 750 that are connected via an isolation module 710. The processing module 750 includes a deposition source 760 comprising an array of inkjet nozzles configured to eject polymer droplets or a shower-head for emitting a chemical vapor toward a web substrate 220. The air pressure in a processing region 770 is much higher than that of the processing module 200 (e.g. at 5 mTorr for sputtering deposition). To isolate the processing modules 200 and 750, the isolation module 710 includes multiple compartments 720-740 that are separated by segregation walls each comprising a small-gap slit to allow the web substrate 220 to continuously pass through. The compartments 720-740 are pumped by separate pumping systems. The small-gap slits however are small enough to maintain sufficient pressure differences between neighboring compartments 720-740 when they are being dynamically pumped by independent pumping systems.

The compartments 720-740 are differentially pumped by the vacuum systems. Differential pumping is a staged pumping scheme that is used to connect and maintain vacuum chambers of very different pressures. It can be described as follows. A vast majority of the gas that migrated from the processing module 750 via (extended) flanges 755 is first exhausted from the compartment 740 by its associated pumping system. The small amount residual gas migrated from the compartment 740 to the compartment 730 thorough the thin slit is again mostly removed by the vacuum pump connected to the compartment 730. The minute amount of gas material migrated from the compartment 730 to the compartment 720 is again removed by the vacuum pump connected to the compartment 720. Therefore, the pressures in the compartments 740, 730, 720 gradually decrease, which dynamically maintains pressure differential between the higher-pressure processing module 750 and the lower-pressure processing module 200. The number of sequentially connected compartments can be varied according to the needs of applications.

Depending on the processing techniques employed, the processing pressure in the processing module 200 can be ˜1 mTorr to 500 mTorr; accordingly, the pressure in the compartment 720 can be ˜10 mTorr to 5 Torr; that in the compartment 730 can be ˜100 mTorr to 50 Torr; and that in the compartment 740 can be ˜1 Torr to 100 Torr; finally, the pressure in the processing module 750 can be 10 Torr up to 760 Torr (at atmospheric pressure). In other words, the pressure ratio between the processing module 750 and the processing module 200 can be higher than 100, or higher than 1000.

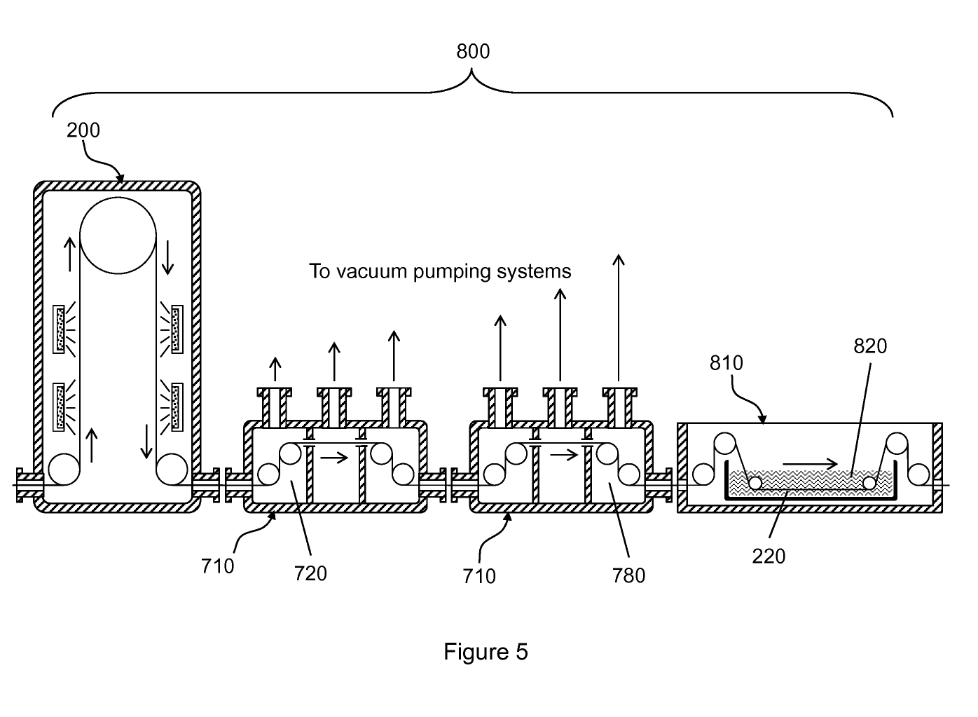

The continuous-substrate processing system 700 can be expanded to include multiple differential pumping modules. Referring to FIG. 5, a deposition system 800 includes a vacuum processing module 200 and a processing module 810 that provides processing in a non-vacuum environment. For example, the processing module 810 can provide wet solution-based processing such as chemical bath deposition at atmospheric pressure. The web substrate 220 is immersed in a solution 820 that contains the deposition material. Two or more isolation modules 710 are placed in between the vacuum processing module 200 and the solution-based processing module 810 to balance the greater pressure difference between the vacuum processing module 200 and the processing module 810. Each of the isolation modules 710 includes multiple compartments that are pumped individually by the vacuum pumping systems. Such multi-staged differential pumping can achieve a pressure differential of ˜1 mTorr to 10 mTorr in the processing module 200 and atmospheric pressure in the processing module 810.

Devices and materials suitable for the disclosed continuous-substrate processing apparatus include OLEDs (organic light-emitting devices), metal oxide TFFs (thin film transistors), TCOs (transparent conductive oxides), RFID (radio frequency identification) tags, and encapsulation materials. Substrates compatible with the disclosed processing apparatus include flexible materials such as stainless foils, polymer webs, and paper, as well as small rigid substrates (e.g. silicon wafers, glass plates) or workpieces (e.g. coronary stents, drill bits and jewelries) that are carried by or attached to a continuous web or tape.

Only a few examples and implementations are described. Other implementations, variations, modifications and enhancements to the described examples and implementations may be made without deviating from the spirit of the present invention. For example, the disclosed apparatus and system can be suitable for other deposition or processing techniques that are not described in the examples above. The exact configurations (shapes, dimensions, orientations and layouts) of the processing modules, the isolation modules, and differential pumping modules can differ from the examples illustrated above without deviating from the spirit of the invention. The web substrate can be made of materials other than the examples described above.

What is claimed is:

1. A processing system, comprising:
a first processing module comprising:
a first chamber; and
a first processing source configured to deposit a first material on a web substrate;
an isolation module, comprising:
an isolation chamber; and
one or more segregation walls that define a sequence of compartments in the isolation chamber, wherein the first chamber is connected to a first compartment in the sequence of compartments, wherein each of the one or more segregation walls includes an opening to allow the web substrate to pass through;
a second processing module, comprising:
a second chamber in connection with a last compartment in the sequence of compartments in the isolation module; and
a second processing source configured to deposit a second material on the web substrate; and
a transport mechanism configured to move the web substrate continuously through the first processing module, the isolation module, and the second processing module.

2. The processing system of claim 1, wherein the first chamber and the isolation chambers respectively comprise flanges that connect the first chamber and the isolation chamber, wherein the web substrate is transported through the flanges.

3. The processing system of claim 1, wherein the second chamber and the isolation chambers respectively comprise flanges that connect the isolation chamber and the second chamber, wherein the web substrate is transported through the flanges.

4. The processing system of claim 1, further comprising:
one or more vacuum pumps each configured to exhaust gas in one of the compartments in the isolation chamber.

5. The processing system of claim 4, wherein the first chamber is configured to be exhausted to a first pressure when the first material is deposited on the web substrate, wherein the second chamber is configured to be exhausted to a second pressure when the second material is deposited on the web substrate, wherein the first pressure is in a range between 1 mTorr to 500 mTorr and wherein the second pressure is in a range between 10 Torr˜760 Torr.

6. The processing system of claim 5, wherein the second processing source is configured to deposit the second material on the web substrate by immersing the web substrate in a solution that contains the second material.

7. The processing system of claim 4, wherein the first chamber is configured to be exhausted to a first pressure when the first material is deposited on the web substrate, wherein the second chamber is configured to be exhausted to a second pressure when the second material is deposited on the web substrate, wherein a ratio of the first pressure to the second pressure is higher than 100.

8. The processing system of claim 7, wherein a ratio of the first pressure to the second pressure is higher than 1000.

9. The processing system of claim 4, wherein the second processing source is configured to deposit the second material on the web substrate by inkjet printing.

10. The processing system of claim 4, wherein the second processing source comprises a shower-head that is configured to emit a chemical vapor to deposit the second material on the web substrate.

11. The processing system of claim 1, wherein the first chamber is configured to be exhausted to a first pressure when the first material is deposited on the web substrate, wherein the second chamber is configured to be exhausted to a second pressure when the second material is deposited on the web substrate, wherein the first pressure is in a range between 1 mTorr to 30 mTorr and wherein the second pressure is in a range between 10⁻⁴˜10⁻⁵ Torr.

12. The processing system of claim 1, wherein the first chamber is configured to be exhausted to a first pressure when the first material is deposited on the web substrate, wherein the second chamber is configured to be exhausted to a second pressure when the second material is deposited on the web substrate, wherein at least one of the compartments in the isolation chamber is kept at a third pressure higher than the first pressure and the second pressure by pumping in an inert gas in the one of the compartments.

13. The processing system of claim 12, wherein the third pressure the one of the compartments in the isolation chamber is kept 1 mTorr˜5 mTorr at higher than the first pressure and the second pressure.

14. The processing system of claim 1, wherein the first processing source is configured to deposit the first material on the web substrate by sputtering, thermal evaporation, electron-beam evaporation, plasma enhanced chemical vapor deposition, or atomic layer deposition.

15. The processing system of claim 1, wherein the web substrate is made of a steel foil, a polymer web, and a paper web.

16. The processing system of claim 1, further comprising:
a rigid substrate or a rigid workpiece on the web substrate, wherein an outer surface of the rigid substrate or the rigid workpiece is configured to receive the first material from the first processing source and the second material from the second processing source.

17. The processing system of claim 1, wherein the first processing module further comprises a third processing source configured to deposit a third material on the web substrate, wherein the first processing source and the third processing source are configured to deposit the first material and the third material on opposite surfaces of the web substrate.

18. The processing system of claim 16, wherein the first material is substantially the same as the third material.

19. A processing system, comprising:
a first processing module comprising:
a first chamber; and
a first processing source configured to deposit a first material on a web substrate;
a first isolation module, comprising:
a first isolation chamber; and
one or more segregation walls that define a sequence of compartments in the first isolation chamber, wherein the first chamber is connected to a first compartment in the sequence of compartments in the first isolation chamber, wherein each of the one or more segregation walls includes an opening to allow the web substrate to pass through;
a second isolation module, comprising:
a second isolation chamber; and
one or more segregation walls that define a sequence of compartments in the second isolation chamber, wherein a last compartment in the first isolation chamber is connected to a first compartment in the sequence of compartments in the second isolation chamber, wherein each of the one or more segregation walls includes an opening to allow the web substrate to pass through;
a second processing module, comprising:
a second chamber configured to receive the web substrate from a last compartment in the sequence of compartments in the second isolation module; and
a second processing source configured to deposit a second material on the web substrate; and
a transport mechanism configured to move the web substrate continuously through the first processing module, the first isolation module, the second isolation module, and the second processing module.

20. A double-sided processing module, comprising:
a chamber comprising an entry slit and an exit slit that are configured to pass through a web substrate, wherein the web substrate comprises a first surface and a second surface;
a wrap-around roller configured to be in contact with the second surface of the web substrate;
a transport mechanism configured to move the web substrate continuously through the entry slit, wrapped around wrap-around roller, and through the exit slit;
a first processing source positioned upstream t the wrap-around roller, wherein the first processing source is configured to deposit a first material on the first surface of the web substrate; and
a second processing source positioned downstream the wrap-around roller, wherein the second processing source is configured to deposit a second material on the second surface of the web substrate.
